(19) United States
(12) Patent Application Publication
(10) Pub. No.: US 2016/0341859 A1
(43) Pub. Date: Nov. 24, 2016

(54) TAG WITH A NON-METALLIC METASURFACE THAT CONVERTS INCIDENT LIGHT INTO ELLIPTICALLY OR CIRCULARLY POLARIZED LIGHT REGARDLESS OF POLARIZATION STATE OF THE INCIDENT LIGHT

(71) Applicant: Board of Regents, The University of Texas System, Austin, TX (US)

(72) Inventors: Gennady Shvets, Austin, TX (US); Chih-Hui Wu, Hillsboro, OR (US); Igal Brener, Albuquerque, NM (US)

(21) Appl. No.: 14/719,414

(22) Filed: May 22, 2015

(51) Int. Cl. G02B 5/30; G02B 27/28; G02B 1/00

(52) U.S. Cl. CPC G02B 5/3025; G02B 1/002; G02B 27/286; B82Y 20/00

(57) ABSTRACT

An optical device for generating narrow-band circularly and elliptically polarized radiation, either by conversion from externally incident light or through thermal emission of heated objects. The optical device includes a metasurface comprised of unit cells, where each unit cell contains structural elements or features that break two mirror inversion symmetries of the unit cell and couple bright and dark resonances. In this manner, the optical device emits circularly polarized radiation that does not exhibit a preference for right-hand circularly polarized light or left-hand circularly polarized light incident upon it. As a result, multiple of such optical devices with different unit cell sizes, geometries and dimensions of the intra-cell elements may be implemented as a tag that thermally emits different states of circularly polarized radiation confined to multiple spectrally-narrow bands. Since the optical device can be fabricated in CMOS, the tag can be used for preventing/identifying tampering with genuine electronic components.

### GOVERNMENT INTERESTS

This invention was made with government support under Grant No. N00014-13-1-0837 awarded by the Office of Naval Research, Grant No. DMR 1120923 awarded by the National Science Foundation and Grant No. DE-AC04-94AL85000 awarded by the Department of Energy. The U.S. government has certain rights in the invention.

### TECHNICAL FIELD

The present invention relates generally to metasurfaces, and more particularly to a tag with a non-metallic metasurface that converts incident light into elliptically or circularly polarized light regardless of the polarization state of the incident light.

### BACKGROUND

Metasurfaces are the two-dimensional single-layer counterparts of the fully three-dimensional metamaterials. Because their fabrication is considerably simpler in comparison with volumetric metamaterials, metasurfaces were the first to find practical applications at optical frequencies ranging from light manipulation and sensing of minute analyte quantities to nonlinear optics, spectrally-selective thermal emission and even low-threshold lasing. Many of these applications require photonic structures characterized by their highly spectrally-selective response (corresponding to high quality factor Q), miniaturized format (preferably on the scale of no more than several wavelengths), and the convenience and high efficiency of far-field light coupling. The coupling efficiency issue, while seemingly mundane, is particularly important for mid-infrared applications because of the lack of ultra-sensitive optical detectors in that frequency range.

Simultaneously satisfying these requirements presents considerable challenge for most photonic structures. For example, the isolated high-micro-cavities suggested for biochemical sensing applications suffer from poor far-field coupling. Planar photonic crystals are also known to possess extremely spectrally-selective optical responses (e.g., reflection and transmission amplitudes or phases) that have been exploited for various sensing and filtering applications. The very high quality factors Q>1,000 of such photonic resonances are often due to the so-called guided resonance modes (GRMs). The spectrally narrow linewidth of these modes originates from the suppression of their radiative losses through the long-range destructive interference between multiple unit cells of a photonic crystal, and, therefore, is extremely sensitive to the light's incidence angle. Such angular sensitivity prevents miniaturization of photonic crystal devices and imposes severe restrictions on the angular divergence of the incident light beams. While highly collimated laser beams have been used for interrogating high-Q photonic crystal structures in the visible and telecommunications spectral ranges, the angular divergence of incoherent beams used for mid-infrared spectroscopy is typically prohibitively high for utilizing GRMs supported by photonic crystals. It is noted that high angular sensitivity is also typical for the frequency-selective surfaces that can be thought of as microwave predecessors of metasurfaces.

Metasurfaces avoid these limitations by employing a conceptually different design approach: its unit cell and its neighboring interactions are engineered to reduce the combined radiative and non-radiative (i.e., ohmic) losses of the sharp resonances. Here, the radiative losses are reduced by engineering the detailed geometry of the metasurface unit cells, while the non-radiative losses are reduced by judiciously selecting the unit cell material. One promising approach to decreasing radiative losses while maintaining finite coupling to free-space radiation is to utilize the phenomenon of Fano interference originally introduced in atomic physics to describe asymmetrically shaped ionization spectral lines of atoms. More recently, the concept of Fano resonances was introduced to the field of photonics and metamaterials in which a photonic structure possesses two resonances generally classified as “bright” (i.e., spectrally broad and strongly coupled to incident light) and “dark” (i.e., spectrally sharp, with negligible radiative loss). The weak near-field coupling between the bright and dark resonances leads to coupling of the incident light to the dark resonance which maintains its low radiative loss, thereby remaining high-Q.

Unfortunately, even for the most judicious engineering of the radiative loss, the total is limited by the non-radiative loss of the underlying material. A notable exception is the special class of diffraction-coupled plasmonic arrays which rely on the geometric resonance that arises when the wavelength of light is commensurate with the array's periodicity. Such plasmonic arrays can possess a very high Q-factor, but suffer from the same limitations as GRM-based photonic crystals, affecting a number of important applications that involve ultra-small (several wavelengths in size) samples. A typical example of such an application is an infrared absorption sensor capable of resolving proteins' secondary structure, which would require mid-infrared metamaterial resonances with Q˜100 to distinguish between their alpha-helical and beta-sheet conformations that fall inside the Amide I (1500 cm⁻¹<ω<1700 cm⁻¹) range. An equally important practical consideration is that the noble metals used for making high-Q plasmonic metasurfaces cannot be processed at CMOS-compatible fabrication facilities, thus limiting their scalability and standardization.

One approach to reducing non-radiative losses without utilizing diffractive effects is to substitute metallic metamaterials with dielectric ones. Although the electromagnetic properties of dielectric resonators have been studied for decades, all-dielectric infrared metamaterials have only recently been demonstrated, and other non-metallic materials are being considered. Despite this body of work, experimentally demonstrating sharp metamaterial resonances (Q˜100) has proven to be challenging, thus greatly impeding further progress in applying metamaterials to practical problems, such as biochemical sensing.

Thus, there has not currently been a means for utilizing silicon-based infrared metasurfaces that support Fano resonances with high quality factors (e.g., Q>100).

### BRIEF SUMMARY

In one embodiment of the present invention, an optical device comprises a substrate. The optical device further comprises a non-metallic metasurface positioned on top of the substrate, where the metasurface comprises a plurality of unit cells. Each of the plurality of unit cells comprises structural elements or features that break two mirror inversion symmetries of the unit cell and couple bright and dark resonances.

The foregoing has outlined rather generally the features and technical advantages of one or more embodiments of the present invention in order that the detailed description of the present invention that follows may be better understood. Additional features and advantages of the present invention will be described hereinafter, which may form the subject of the claims of the present invention.

### BRIEF DESCRIPTION OF THE DRAWINGS

A better understanding of the present invention can be obtained when the following detailed description is considered in conjunction with the following drawings, in which:

FIG. 1A illustrates an SEM image of an optical device comprising a silicon-based chiral metasurface supporting high-Q Fano resonances in accordance with an embodiment of the present invention;

FIG. 1B illustrates that the metasurface is comprised of unit cells, where each unit cell is comprised of one straight silicon nanorod and one bent silicon nanorod, in accordance with an embodiment of the present invention;

FIG. 1C is a schematic illustrating the Fano interference between electric dipolar (top left) and quadrupolar (bottom left) modes due to the symmetry-breaking small horizontal stub for the unit cells with two straight silicon nanorods and for the unit cells with a single straight silicon nanorod and a single bent silicon nanorod in accordance with an embodiment of the present invention;

FIGS. 2A-2D are maps of E_{y} in the x-y plane (left) and x-z plane (right) in accordance with an embodiment of the present invention;

FIGS. 2E and 2F illustrate the cutting planes in accordance with an embodiment of the present invention;

FIGS. 3A-3F present the experimental and numeral results, where the cross-polarized transmission spectra Tᵢⱼ(λ) are acquired using polarized infrared spectroscopy, are plotted as a function of the wavelength in accordance with an embodiment of the present invention;

FIG. 4A is a schematic for the rotating analyzer Stokes polarimetry in accordance with an embodiment of the present invention;

FIG. 4B illustrates the definition of the polarization ellipse parameters in accordance with an embodiment of the present invention;

FIG. 4C illustrates the measured tilt angle β and the inverse ellipticity b/a of the polarization ellipse in accordance with an embodiment of the present invention;

FIG. 4D illustrates the measured Stokes parameters for the L=1.8 μm sample in accordance with an embodiment of the present invention;

FIG. 5 is a table (Table 1) illustrating the comparison of dark modes supported by the silicon metasurface in accordance with an embodiment of the present invention;

FIG. 6A illustrates the numerical (COMSOL) simulation of the cross-polarized reflectivity matrix R_{α,β} in the circularly polarized basis in accordance with an embodiment of the present invention;

FIG. 6B illustrates the simulation of the air-side cross-polarized transmission matrix T_{α,β} in accordance with an embodiment of the present invention;

FIG. 6C illustrates the estimated degree of circular polarization (DCP) of thermal infrared radiation emitted by an IR-absorbing slab capped by the two-dimensional chiral metasurface in accordance with an embodiment of the present invention; and

FIG. 7 illustrates an embodiment of a tag containing pixels, where each of the pixels includes the unit cells of FIGS. 1A and 1B in accordance with an embodiment of the present invention.

### DETAILED DESCRIPTION

The principles of the present invention allow an experimental realization of silicon-based infrared metasurfaces supporting Fano resonances with record-high quality factors Q>100. In addition, as discussed herein, the principles of the present invention experimentally demonstrate that high (>50%) linear-to-circular polarization conversion efficiency can be accomplished by making these silicon-based metasurfaces planar (2D) chiral by design. The supporting numerical simulations indicate that such metasurfaces can exhibit an extraordinary degree of planar chirality, thus opening exciting possibilities for developing narrow-band thermal emitters of circularly polarized radiation. In one embodiment, Si-based metasurfaces are fabricated from standard commercially available silicon-in-insulator (SOI) wafers using standard CMOS-compatible semiconductor fabrication techniques, making them even more appealing for practical applications.

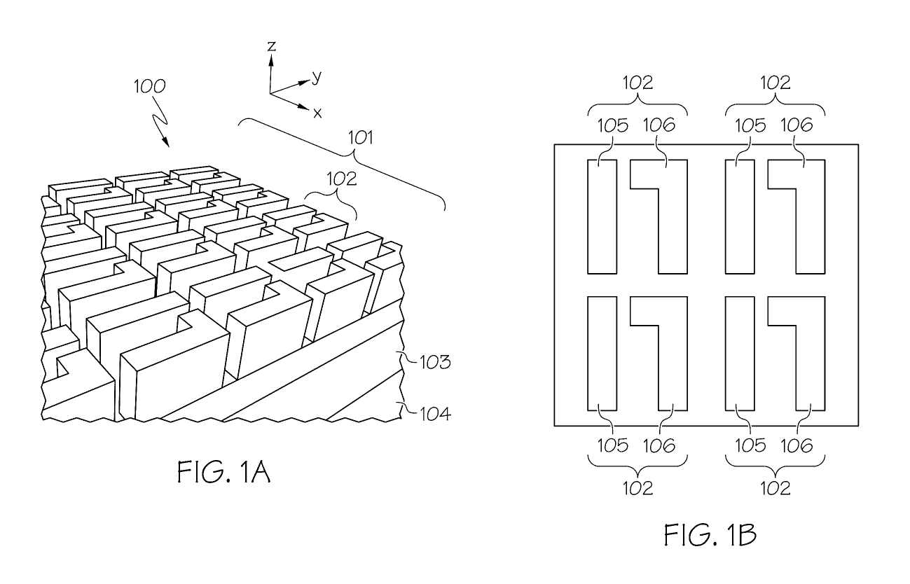

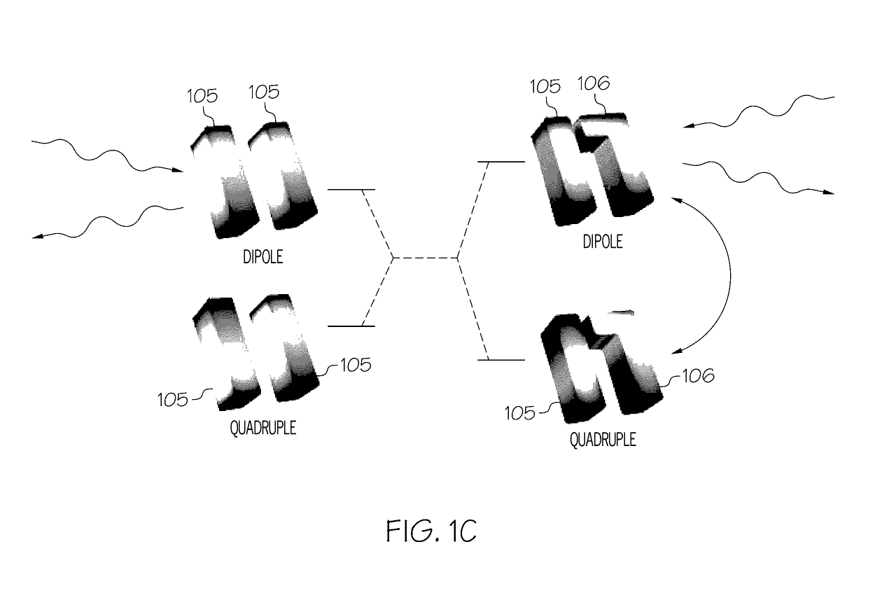

Referring now to the Figures in detail, FIG. 1A illustrates an SEM image of an optical device 100 comprising a silicon-based chiral metasurface 101 supporting high-Q Fano resonances in accordance with an embodiment of the present invention. As illustrated in FIG. 1A, optical device 100 includes a metasurface 101 comprising a plurality of unit cells 102 (shown in further detail in FIG. 1B) made of silicon that is placed on a dielectric layer 103 of silicon dioxide which is positioned on substrate 104 comprised of silicon. In one embodiment, metasurface 101 may be transferred directly to substrate 104 thereby foregoing the need for dielectric layer 103 in optical device 100. In one embodiment, dielectric layer 103 can have a vanishing (zero) thickness. Each of the unit cells 102 includes structural elements or features that break two mirror inversion symmetries of the unit cell 102 and couple bright and dark resonances. An embodiment of unit cell 102 having a straight silicon nanorod and one bent silicon nanorod is discussed below. In one embodiment, the thickness of metasurface 101 ranges from approximately 200 nanometers to approximately 2.5 micrometers. While the following discusses the silicon-based metasurface as being fabricated from an SOI wafer, the principles of the present invention are not to be limited in scope in such a manner. The silicon-based metasurface may be transferred to other substrates, such as heated objects, ranging from a desk to a human skin. A person of ordinary skill in the art would be capable of applying the principles of the present invention to such implementations. Further, embodiments applying the principles of the present invention to such implementations would fall within the scope of the present invention.

FIG. 1B illustrates that metasurface 101 is comprised of unit cells 102, where each unit cell 102 is comprised of one straight silicon nanorod 105 and one bent silicon nanorod 106, in accordance with an embodiment of the present invention. In one embodiment, the dimension of unit cells 102 shown in FIG. 1B is as follows: P=2.4 μm, w=500 nm, d=700 nm, g=200 nm, R=2 μm, and 1.6 μm<L<2 μm L. In one embodiment, the dimensions of unit cells 102 (i.e., the dimensions of nanorods 105, 106) are based on the wavelength of the externally incident light or the wavelength of the thermally emitted light. Furthermore, in one embodiment, the thickness of metasurface 101 is based on the wavelength of the externally incident light or the wavelength of the thermally emitted light. In one embodiment, the wavelength of the externally incident light or the wavelength of the thermally emitted light is between approximately 1 micrometer and approximately 100 micrometers.

In one embodiment, the bend in the bent silicon nanorod 106 is responsible for breaking the two mirror inversion symmetries of unit cell 102 and coupling the bright (electric dipole) and dark (electric quadrupole/magnetic dipole) resonances as schematically shown in FIG. 1C, where the surface charge density at the air/Si interface is plotted for the eigenmodes of the metasurfaces with and without a symmetry-breaking bend.

FIG. 1C is a schematic illustrating the Fano interference between electric dipolar (top left) and quadrupolar (bottom left) modes due to the symmetry-breaking small horizontal stub for the unit cells with two straight silicon nanorods and for the unit cells (unit cells 102) with a single straight silicon nanorod and a single bent silicon nanorod in accordance with an embodiment of the present invention. The plotted shaded-coded surface charge distributions at the Si/air interfaces are calculated from eigenvalue simulations of the fields supported by metasurface 101. The modes approximately retain their spatial symmetry after hybridization.

Because collective interactions of each unit cell 102 with its neighbors are important for imparting metasurface 101 with its optical properties, the eigenmodes of an infinite metasurface were calculated using finite-elements methods COMSOL software. It is noted that the diffractive effects are unimportant in Fano-resonant metasurfaces 101, and the spectral position of the dark resonance is determined primarily by the geometry of unit 102 (its physical dimensions R, L, g, d, and w shown in FIG. 1B) and not by the period P separating them. Hybridization of the two resonances is responsible for the very sharp Fano features in transmission and reflection spectra as the dark resonance acquires a small electric dipole moment and strongly couples to the incident electromagnetic wave.

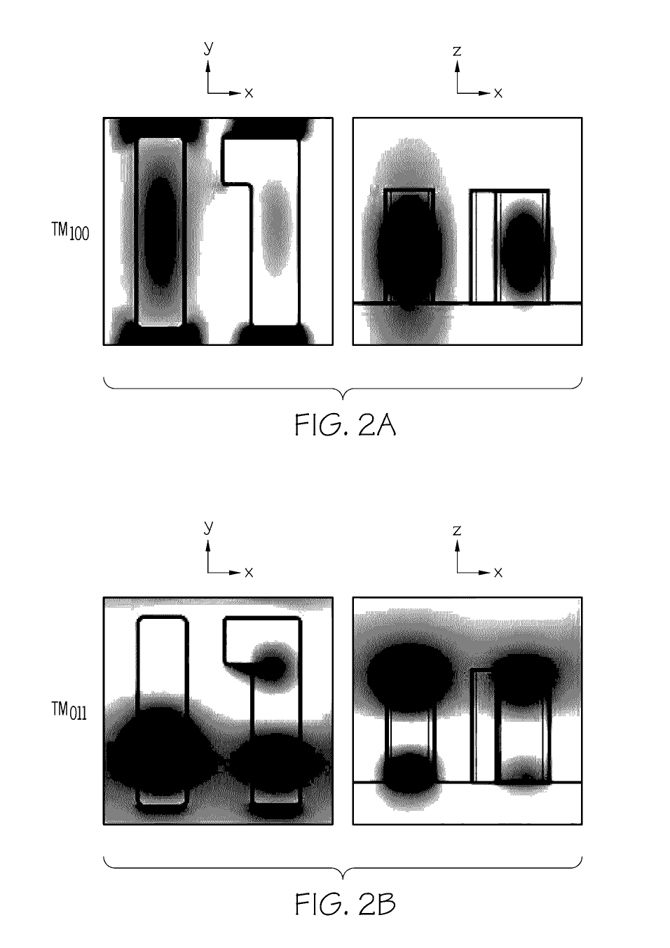

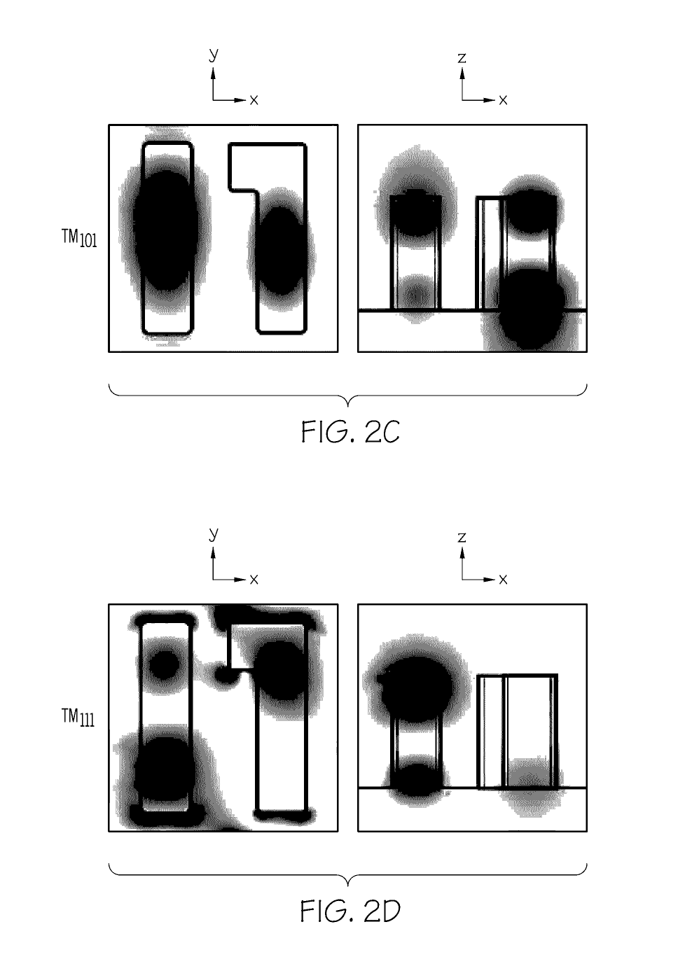

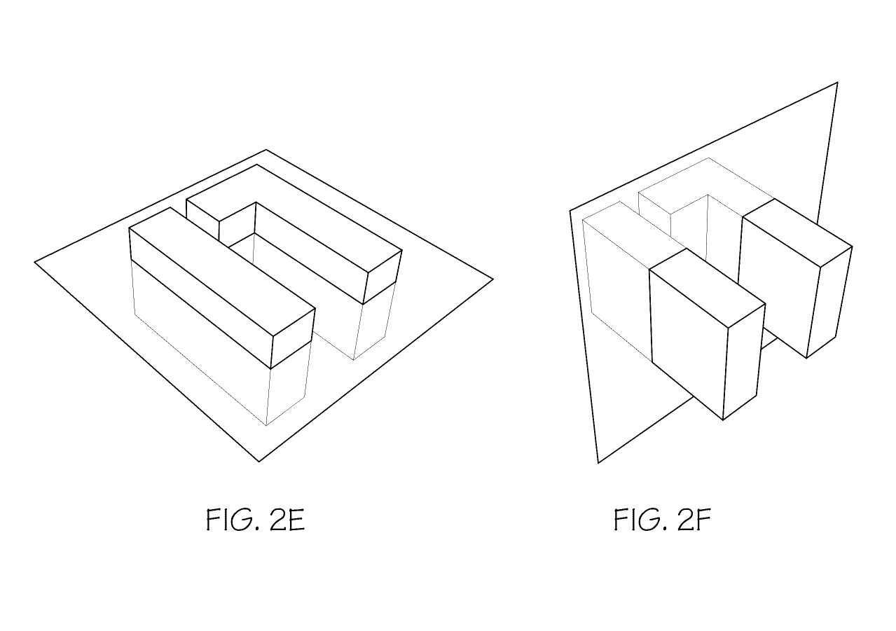

The dark quadrupole resonance is not the only high-Q eigenmode supported by metasurface 101. In fact, several strongly localized dark multiple resonances shown in FIGS. 2A-2F are supported. FIGS. 2A-2D are maps of E_{y} in the x-y plane (left) and x-z plane (right) in accordance with an embodiment of the present invention. FIGS. 2E and 2F illustrate the cutting planes in accordance with an embodiment of the present invention. The x-z plane passes through the middle of unit cell 102 (FIGS. 1A and 1B). The corresponding resonant wavelengths are λ₁₀₀=4.72 μm, λ₀₁₁=4.21 μm, λ₁₀₁=4.12 μm, and λ₁₁₁=4.07 μm, respectively. In one embodiment, the physical dimension of the metasurface is the same as FIGS. 1A-1B, with L=2 μm.

Referring to FIGS. 2A-2F, in conjunction with FIGS. 1A-1C, all resonances were computed for metasurface 101 with the period P=2.4 μm and nanorods' 105, 106 cross-section of 0.5 μm×1.2 μm in the x-z plane, with remaining dimensions discussed above. Based on their spatial symmetry, the resonant modes are designated as TMᵢⱼₖ, with i, j, k=0 or 1 corresponding to the E_{y} (x, y, z) being, respectively, even or odd under the x, y, z inversions. All dark modes are coupled in the near-field to the bright TM₀₀₀ mode, marked as “dipole” in FIG. 1C.

However, because the coupling of the higher-order dark modes to the TM₀₀₀ mode is even weaker than that of the lowest order TM₀₀₀ mode (marked in FIG. 1C as “quadrupole”), it would be expected, and has been experimentally confirmed below, that these modes manifest in even sharper Fano resonances. It is noted that these modes are designated as dark because of their near-vanishing electric and magnetic dipole moments in the x-y plane, and, consequently, weak coupling to the normally incident light. The degree of coupling is controlled by the design: a shorter symmetry-breaking bend of a nanorod would result in weaker coupling and higher quality factor Q. In contrast, the Q-factor of the bright modes possessing the in-plane electric/magnetic dipole moments cannot be arbitrarily increased because of the finite out-of-plane scattering that cannot be suppressed.

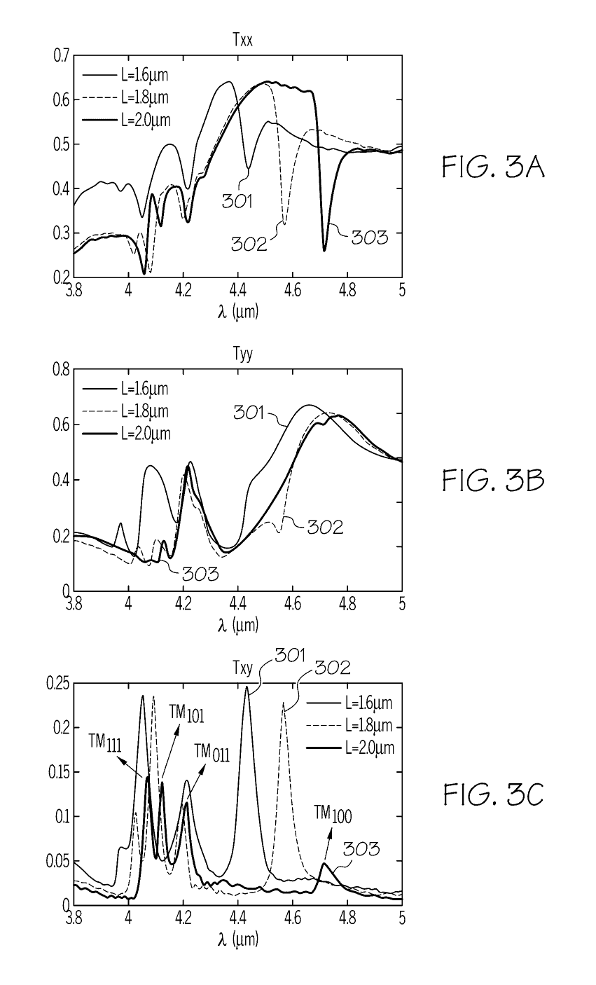

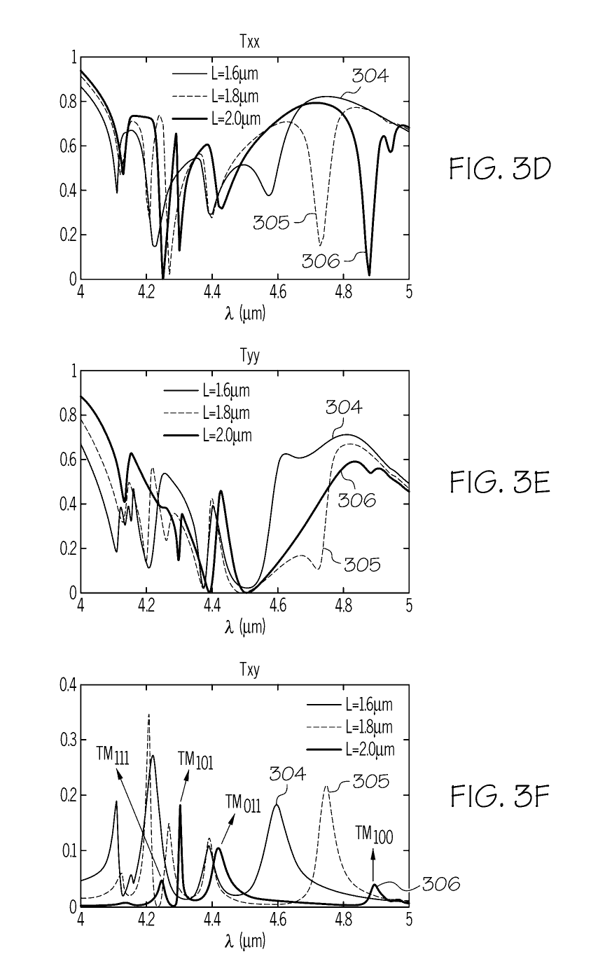

FIGS. 3A-3F present the experimental and numeral results, where the cross-polarized transmission spectra Tᵢⱼ(λ) are acquired using polarized infrared spectroscopy, are plotted as a function of the wavelength in accordance with an embodiment of the present invention. In particular, FIGS. 3A-3C present the measured transmission spectra of the silicon metamaterials with L=1.6 μm (line 301), 1.8 μm (line 302) and 2.0 μm (line 303). FIGS. 3D-3F present the calculated transmission spectra of the silicon metamaterials with L=1.6 μm (line 304), 1.8 μm (line 305) and 2.0 μm (line 306). The spectra of Tₓₓ are shown in FIGS. 3A and 3D, the spectra of T_{yy} are shown in FIGS. 3B and 3E and the spectra of T_{xy} are shown in FIGS. 3C and 3F. The four dark resonances are labeled in FIGS. 3C and 3D for the L=2 μm sample.

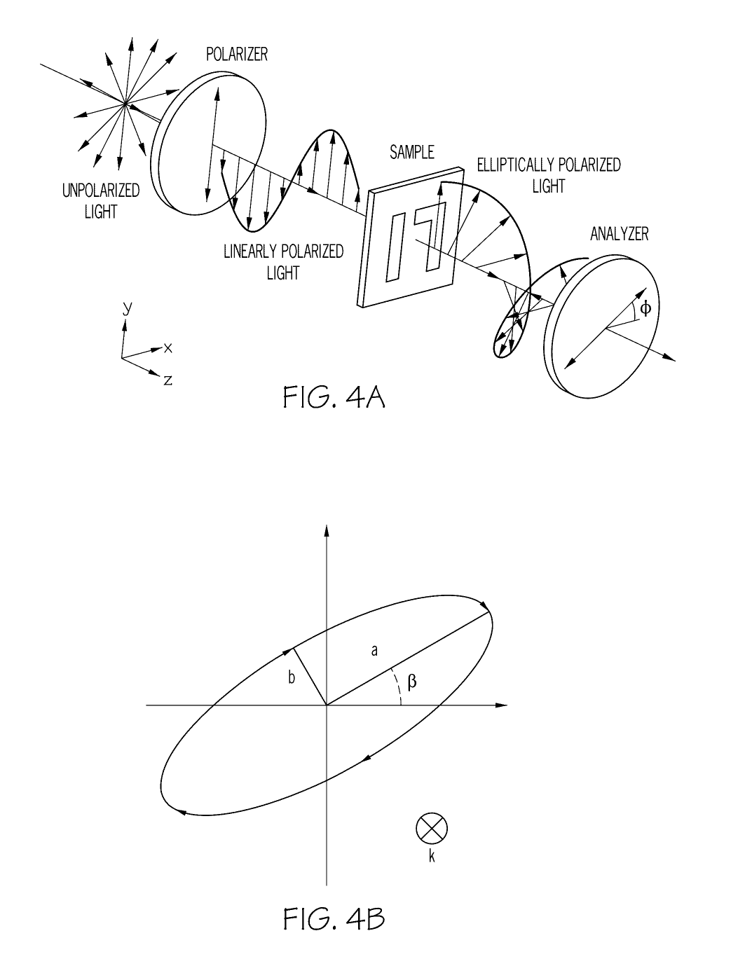

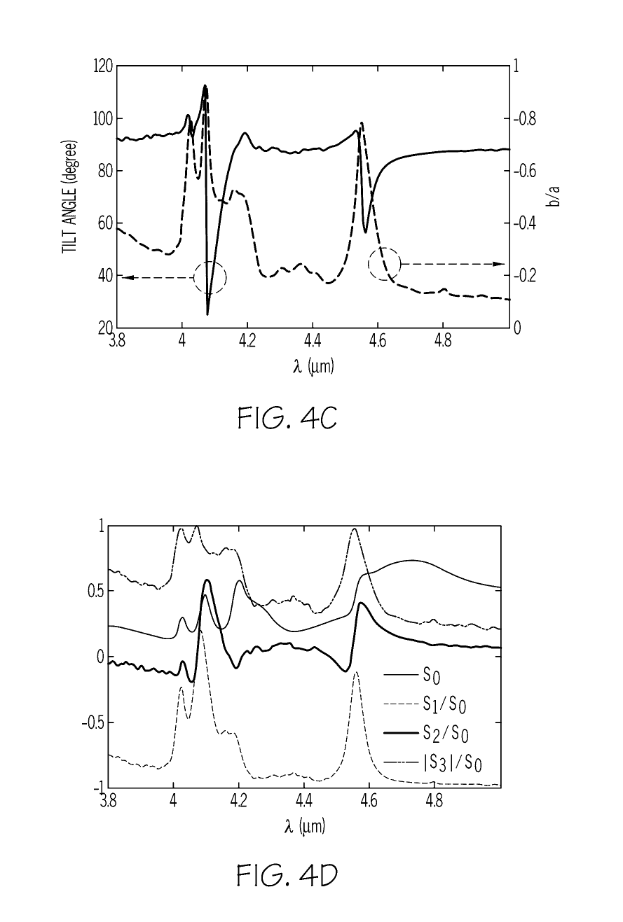

The polarizations of the incident/transmitted light (i, j=x or y) are set by the polarizer/analyzer, respectively, as shown in FIG. 4A (discussed further below).

Referring to FIGS. 3A-3F, in conjunction with FIGS. 1A-1C, spectral tunability of three representative metasurfaces was accomplished by varying the length 1.6 μm<L<2 μm of the straight nanorod 105. The spectra provide clear evidence of the Fano interference consistent with FIG. 1C: a broad dip at the frequency of the bright TM₀₀₀ mode at λ₀₀₀≈4.35 μm is super-imposed on a set of narrow features corresponding to the dark modes shown in FIGS. 2A-2F. Similar Fano features are observed in the x-polarized transmission Tₓₓ(λ), where the broadband background reflectivity originates from the Fabry-Perot substrate resonances.

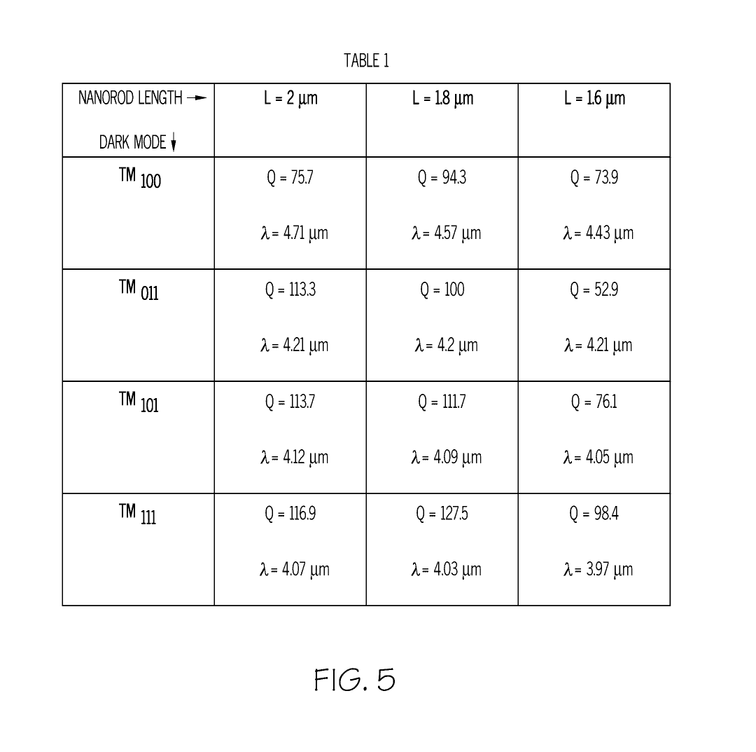

The most remarkable spectral features are observed in the cross-polarized transmission T_{xy}(λ). The baseline T_{xy}(λ), small for all non-resonant wavelengths (λ>5 μm), is dramatically peaked at Fano resonances, as shown in FIGS. 3C and 3F, due to the coupling of the dark modes to both x and y polarizations of the incident light. The estimated quality factors Q=λ/Δλ (where Δλ is full-width half-maximum of each peak) of the Fano resonances, calculated by fitting the experimental cross-polarized spectra with Lorentzian curves, are listed in Table 1 of FIG. 5 for the three metasurfaces. Table 1 is a table illustrating the comparison of dark modes supported by the silicon metasurface in accordance with an embodiment of the present invention. Slightly more accurate values of the Q-factors can be obtained from the cross-polarized spectra by fitting T_{xy}(λ) to the standard Fano expression.

These appear to be the narrowest optical resonances observed in collective mid-IR metasurfaces that do not rely on diffractive effects that become important when the wavelength of light becomes commensurate with the periodicity of the array. Unlike extremely angle-sensitive diffractive structures, Fano-resonant metasurfaces are ideally matched to far-field radiation with moderate angular divergence focused by low numerical aperture (NA) optics (Δθ≈7° and NA≈0.13). Such experimentally observed angular tolerance translates into minimum acceptable metasurface size Wₘ˜λ/(2Δθ) which can be considerably smaller than W_{d}˜Qλ/2 (where λ is the wavelength of the infrared light) required for high-Q diffracting structures, such as those based on GRMs.

Although achieving high-Q resonances depends on collective interactions between neighboring cells of the large area (300 μm×300 μm) metasurfaces used in the experiments of the present invention, the simulations of the present invention confirm that samples as small as 25 μm×12.5 μm (or 6λ×3λ) can be utilized without any noticeable deterioration of the spectral sharpness. That is, because only several neighboring unit cells (2-3 on each side horizontally, 1 on each side vertically) effectively interact with each given unit cell 102. This short-range collective interaction contrasts with long-range coherence required for achieving narrow spectral width in photonic structures that rely on diffractive effects. The unique capability to combine these small area high-Q metasurfaces with thermal infrared radiation sources is useful for the future sensing applications described below.

The first application of the planar (2D) chiral metasurfaces 101 described herein, suggested by the high cross-polarized transmission T_{xy}, is efficient linear-to-circular polarization (LP-to-CP) conversion. The conversion efficiency and the degree of circular polarization (DCP) was experimentally investigated using the standard rotating analyzer Stokes polarimetry setup illustrated in FIG. 4A to characterize the transmitted polarization state of the polarized incident light, and to extract its Stokes parameters

S₀=|Eₓ|²+|E_{y}|²,

S₁=|Eₓ|²−|E_{y}|², S₂=2 Re[EₓE*_{y}], and |S₃|=2 Im[EₓE*_{y}].

FIG. 4A is a schematic for the rotating analyzer Stokes polarimetry in accordance with an embodiment of the present invention. The incident beam is polarized in the y-direction.

Referring to the Stokes parameters discussed above, a nonzero S₃ corresponds to elliptically polarized light, and S₃=±S₀ corresponds to right/left CP light. Alternatively, the principal dimensions of the transmitted light's polarization ellipse, its tilt angle β and the ratio a/b between its long and short axes defined in FIG. 4(b), can be expressed in terms of the Stokes parameters.

FIG. 4B illustrates the definition of the polarization ellipse parameters in accordance with an embodiment of the present invention. FIG. 4C illustrates the measured tilt angle β and the inverse ellipticity b/a of the polarization ellipse in accordance with an embodiment of the present invention. FIG. 4D illustrates the measured Stokes parameters for the L=1.8 μm sample in accordance with an embodiment of the present invention. It is noted that S₁, S₂ and S₃ are normalized with respect to S₀.

The measured Stokes parameters and polarization ellipse dimensions for the metasurface with L=1.8 μm are plotted in FIGS. 4C and 4D, and are in good agreement with numerical simulations. It is noted that away from the Fano resonances, the polarization of the transmitted light is essentially unchanged from its original linear y-polarization, as expressed by S₁/S₀≈−1 in FIG. 4D, and β≈90°, b/a≈0.1 in FIG. 4C for λ>4.7 μm. However, at the Fano resonances, the polarization becomes essentially circular, as evidenced by |S₃|/S₀≈1 and b/a≈0.8 at λ₁₀₀≈4.55 μm, with conversion efficiency S₀≈50%. Even a higher degree of circular polarization (b/a>0.9) is observed for the TM₁₀₁ mode at λ₁₀₁≈4.1 μm, thus demonstrating that these metasurfaces can be used for efficient narrow-band LP-to-CP conversion.

The two-dimensional chiral high-Q silicon metasurfaces described herein make them an attractive platform for a variety of applications that require spectral selectivity, small pixel size, relatively weak angular sensitivity, and strong field enhancement. The simplicity and widespread availability of silicon fabrication techniques used in the semiconductor industry only add to the attractiveness of Si-based metasurfaces for practical applications. Recent advances in transferring the otherwise stiff and brittle silicon structures onto flexible substrates is another potentially important contributing factor to future adoption of Si-based metasurfaces by applications that require conformable or stretchable platforms. As discussed below, the principles of the present invention may be utilized in two potential applications that are enabled by the metasurfaces of the present invention: one is the thermal emission of circularly-polarized infrared radiation, such as from heated objects, enabled by the extreme chirality of Si-based metasurfaces, and the other is sensing and bio-sensing enabled by the strong optical field concentration and spectral selectivity of these Fano-resonant metasurfaces.

The two-dimensional chiral nature of metasurfaces 101 (FIG. 1A) discussed above lends itself to another unique application as a source of spectrally-selective CP thermal IR radiation which is uniquely distinct from the non-CP thermal radiation emitted by natural environments. Even though it is generally assumed that broadband CP emitters are desirable, high spectral selectivity is required for applications, such as infrared identifiers (IRID), which rely on unique spectral and polarization signatures of IR tags. A discussion regarding the conceptual differences between two-dimensional chiral metasurfaces and other metamaterials used for LP-to-CP conversion, such as the single-layer plasmonic quarter-wave plates or chiral volumetric metamaterials, is now deemed appropriate.

The action of a quarter-wave plate is based on the phenomenon of birefringence, due to which the two orthogonal polarizations of light acquire different phase shifts φ_{x,y} in transmission. The transmitted LP light can be converted into a right-hand circularly polarized light (RCP) or left-hand circularly polarized light (LCP) polarization state if the phase difference Δφ=φₓ−φ_{y}=±π/2. By changing the initial direction of the incoming LP polarization, either RCP or LCP states can be achieved. While quarter-wave plates based on birefringent metasurfaces can be used for efficient LP-to-CP polarization conversion, they cannot be used as stand-alone elements for controlling the polarization state of thermal radiation driven by unpolarized electromagnetic fluctuations dictated by the fluctuation-dissipation theorem.

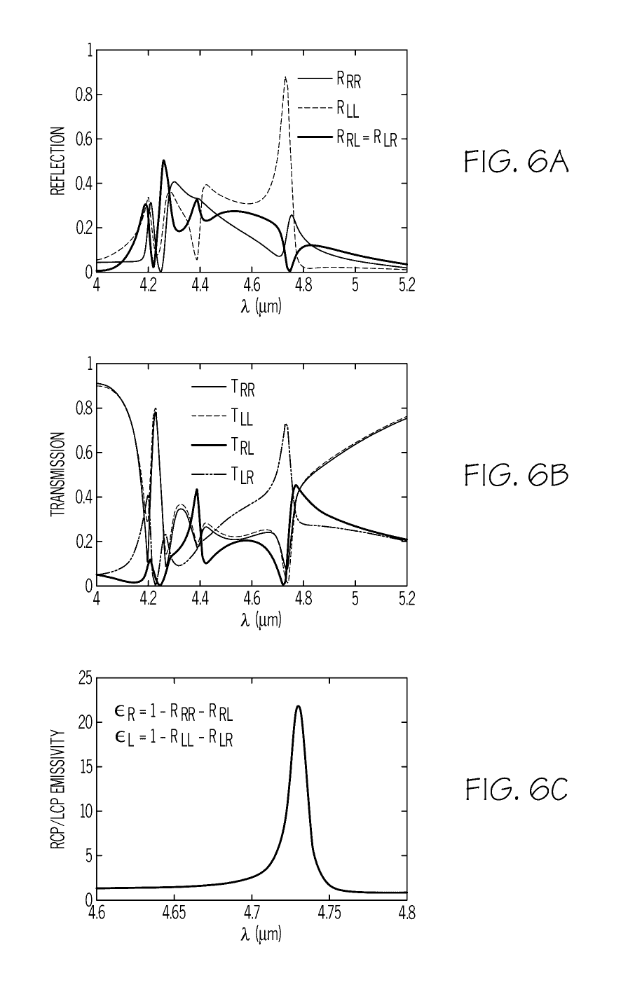

On the contrary, it can be demonstrated that the two-dimensional chiral metasurface 101 shown in FIG. 1A transmits primarily one CP state. To see this, note that the air-side transmission through metasurface 101 is highly unusual as indicated by the results of the COMSOL simulations shown in FIGS. 6A-6C. FIG. 6A illustrates the numerical (COMSOL) simulation of the cross-polarized reflectivity matrix R_{α,β} in the circularly polarized basis in accordance with an embodiment of the present invention. In one embodiment, such circularly polarized radiation is configured to multiple spectral bands. FIG. 6B illustrates the simulation of the air-side cross-polarized transmission matrix T_{α,β} in accordance with an embodiment of the present invention. FIG. 6C illustrates the estimated degree of circular polarization (DCP) of thermal infrared radiation emitted by an IR-absorbing slab capped by the two-dimensional chiral metasurface 101 in accordance with an embodiment of the present invention.

As discussed above, it has been demonstrated that the two-dimensional chiral metasurface 101 shown in FIG. 1A transmits primarily one CP state. For example, for a planar non-chiral interface one expects that the diagonal elements of the cross-polarized transmission matrix T_{α,β} (λ) in the circularly polarized basis (α,β: RCP or LCP) dominate over the polarization-converting off-diagonal elements for all wavelengths λ. This is clearly not the case for the studied two-dimensional chiral metasurfaces: according to FIG. 6B, the diagonal elements are very small while the off-diagonal element T_{LR} is dominant at the resonant wavelength λ_{F}≈4.7 μm. That is, the generated polarized radiation does not exhibit a preference for right-hand circularly polarized light or left-hand circularly polarized light. Because of the resonant nature of the metasurface, the RCP-to-LCP and LCP-to-RCP transmission coefficients differ significantly at Fano resonances: T_{LR}>>T_{RL} despite that T_{LL≈}T_{RR} as expected for non-3D chiral metamaterials with small substrate effects. This extreme chirality implies that, unlike in the case of a birefringent metasurface, the transmitted radiation is primarily CP even for unpolarized incident light. Depending on the position of the nanorod's bend, the resulting CP state can be engineered to be either mostly LCP (if T_{LL≈}T_{RR}≈0 and T_{LR}>>T_{RL} as shown in FIG. 6B) or mostly RCP (if T_{LR}<<T_{RL}). Here L stands for left-hand circularly polarized radiation and R stands for right-hand circularly polarized radiation.

The strong asymmetry of the total transmission of the two circular polarization states through two-dimensional chiral dielectric metasurface 101 makes it very distinct from ultra-thin two-dimensional chiral metallic metasurfaces that rely on either ohmic dissipation or symmetry-breaking substrate effects to achieve such transmission asymmetry. Numerical simulations (not shown) indicate that even in the absence of substrate effects (i.e., when the z→−z special inversion symmetry is preserved) and dissipation (which is negligible in Si for mid-IR frequencies) it is possible for the total transmission of the RCP light, T_{R}=T_{RR}+T_{LR}, to be different from the total transmission of the LCP light, T_{L}=T_{LL}+T_{RL}. The physical reason for this is that the combination of spatial inversion and time reversal symmetries only enforces the T_{LL}=T_{RR} requirement. The T_{LR} ≠ T_{RL} inequality does not violate any symmetry, and does indeed occur for all-dielectric metasurfaces with small but finite thickness.

In fact, it can be shown that a lossless all-dielectric metasurface 101 shown in FIG. 1A embedded in a fully symmetric dielectric environment can be designed to satisfy the following transmission property at a specific wavelength: T_{LL}=T_{RR}=T_{RL}=0 and T_{LR} ≠ 0. Therefore, regardless of the polarization state of the incident radiation, the transmitted radiation's polarization state is always left-hand circularly polarized. Satisfying these conditions of extreme chirality ensures that the total transmission for the left-hand polarized lights, T_{L}≡T_{LL}+T_{RL}=0, is vanishing while the total transmission for the right-hand polarized light, T_{R}≡T_{RR}+T_{LR} ≠ 0, is finite and close to 100%, making metasurface 101 a functional equivalent of an optical device comprised of a quarter-wave plate with principal optical axes (x′, y′), followed by a linear polarizer whose transmission axis is titled at 45° with respect to (x′, y′), followed by an identical quarter-wave plate. Remarkably, this functionality is achieved by a metasurface that is only about a micron thick. Such functionality cannot be accomplished by an ultra-thin two-dimensional chiral metallic metasurface because the continuity of the electric field across the metasurface enforces the T_{LR}=T_{RL} condition for lossless metallic metasurfaces embedded in a symmetric dielectric environment.

Even more significant are the implications of strong spectrally-selective reflection asymmetry (R_{LL} ≠ R_{RR} as shown in FIG. 6A) for applications involving thermal emission of circularly polarized states of light, such as from heated objects, because the emissivity is related to the surface reflectivity through Kirhhoff's Law. For example, the circularly polarized emissivity coefficients ε_{R} (λ) and ε_{L} (λ) for a bulk-absorbing emitter can be expressed as ε_{R}=1−R_{RR}−R_{LR} and ε_{L}=1−R_{LL}−R_{RL}. Thus calculated CP emissivity coefficients plotted in FIG. 6C show a high degree of circular polarization DCP (λ)≡ε_{R}/ε_{L} of the thermal emission at the Fano resonance wavelength λ_{F}: DCP(λ) has a spectral FWHM of δλ_{FWHM}≈30 nm and the peak value of DCP(λ_{F})>20, which is almost two orders of magnitude higher than its baseline value outside of this narrow resonance region. The unique spectral (very narrow band) and polarization (high DCP) characteristics of the thermal radiation produced by the proposed two-dimensional chiral metasurfaces 101 suggests their applications to IRID tags technologies because they can be easily distinguished from the unpolarized thermal radiation emitted by the environment, and because multiple narrow emission bands with high DCP can be used within the atmospheric transparency window (3 μm<λ<5 μm). Although fully-3D helical metamaterials or their multi-layer equivalents can potentially deliver similar performance, their fabrication is considerably more complex than that of a single-layer micron-thick metasurface described herein.

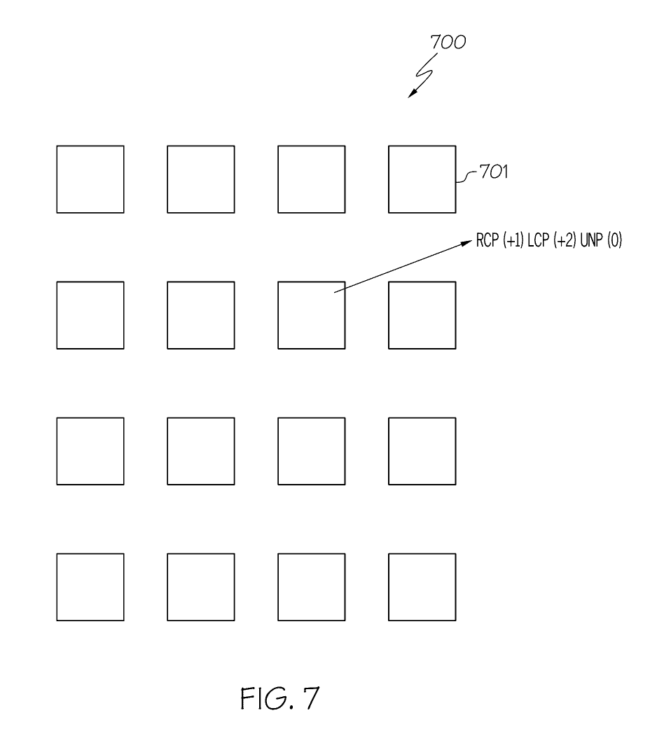

In one embodiment of the present invention, multiple optical devices 100 of FIG. 1A may be utilized as a tag as illustrated in FIG. 7. FIG. 7 illustrates an embodiment of such a tag 700 including a plurality of pixels 701, where each of the pixels 701 includes unit cells 102 of FIGS. 1A-1B, in accordance with an embodiment of the present invention. For example, suppose that tag 700 includes 10 pixels 701, each emitting at a different frequency and each emitting either unpolarized radiation (UNP) (0), or right-hand circularly polarized radiation (RCP) (1), or left-hand circularly polarized radiation (LCP) (2). As a result, tag 700 will essentially have 3 to the power of 10 realizations. For example, one tag 700 may have the realization of (0, 0, 1, . . . ) while another tag 700 will have the realization of (2, 2, 2, . . . ).

The features discussed herein of unit cells 102 of FIGS. 1A-1B apply to unit cells 102 being utilized in tag 700. For example, the generated circularly polarized radiation for each pixel 701 does not exhibit a preference for the incident right-hand circularly polarized light or the left-hand circularly polarized light.

The high-Q Fano-resonant dielectric metasurfaces of the present invention represent a novel and promising platform for a variety of applications that depend on high optical energy enhancement and precise spectral matching between molecular/atomic and electromagnetic resonances. Those include infrared spectroscopy of biological and chemical substances and nonlinear infrared optics. Chiral properties of such metasurfaces might be exploited for developing novel ultra-thin infrared detectors sensitive to light's chirality, as well as spectrally-selective CP thermal emitters. Even higher quality factors (Q>1,000) Fano resonant metasurfaces can be developed by judicious engineering of near-field coupling between resonant modes if inhomogeneous broadening due to fabrication imperfections can be overcome. Combining the large field enhancements achieved in such high-Q silicon metasurfaces with coherent radiation sources, such as quantum cascade lasers capable of delivering high-power low-divergence beams, would open new exciting opportunities in nonlinear infrared optics, such as harmonics generation and four-wave mixing using free-space excitation.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. An optical device comprising:
a substrate; and
a non-metallic metasurface positioned on top of said substrate, wherein said metasurface comprises a plurality of unit cells, wherein each of said plurality of unit cells comprises structural elements or features that break two mirror inversion symmetries of said unit cell and couple bright and dark resonances.

2. The optical device as recited in claim 1, wherein each of said plurality of unit cells is comprised of a single straight silicon nanorod and a single bent silicon nanorod, wherein said bend in said bent silicon nanorod is responsible for breaking two mirror inversion symmetries of said unit cell and coupling bright and dark resonances.

3. The optical device as recited in claim 1, wherein said metasurface generates a circularly polarized radiation by conversion from an externally incident light or through a thermal emission of heated objects.

4. The optical device as recited in claim 3, wherein said optical device is utilized as a tag, wherein said tag comprises a plurality of pixels, wherein each of said pixels comprises said plurality of unit cells.

5. The optical device as recited in claim 4, wherein said generated circularly polarized radiation for each pixel does not exhibit a preference for the incident right-hand circularly polarized light or left-hand circularly polarized light.

6. The optical device as recited in claim 4, wherein said circularly polarized radiation is confined to multiple spectral bands.

7. The optical device as recited in claim 4, wherein each of said plurality of unit cells for each of said pixels is comprised of a single straight silicon nanorod and a single bent silicon nanorod, wherein said bend in said bent silicon nanorod is responsible for breaking two mirror inversion symmetries of said unit cell and coupling bright and dark resonances, wherein dimensions of each of said single straight silicon nanorod and said single bent silicon nanorod are based on a wavelength of said externally incident light or based on a wavelength of a thermally emitted light.

8. The optical device as recited in claim 4, wherein a thickness of said metasurface is based on a wavelength of said externally incident light or based on a wavelength of a thermally emitted light.

9. The optical device as recited in claim 4, wherein a wavelength of said externally incident light or a wavelength of a thermally emitted light is between approximately 1 micrometer and approximately 100 micrometers.

10. The optical device as recited in claim 1, wherein a transmitted radiation of said metasurface is circular polarized for an unpolarized incident light.

11. The optical device as recited in claim 10, wherein a state of said circular polarization is based on a position of a bend of said bent silicon nanorod.

12. The optical device as recited in claim 11, wherein said state of said circular polarization is one of the following: left circular polarization and right circular polarization.

13. The optical device as recited in claim 1, wherein said metasurface exhibits planar chirality.

14. The optical device as recited in claim 1, wherein a thickness of said metasurface is between approximately 200 nanometers and approximately 2.5 micrometers.

15. The optical device as recited in claim 1, wherein said metasurface generates an elliptic polarized radiation.
